(19) United States
(12) Patent Application Publication
(10) Pub. No.: US 2026/0292354 A1
(43) Pub. Date: Sep. 24, 2026

(54) DYNAMIC LIGHTING CONTROL FOR MODULAR INFRASTRUCTURE INSPECTION PLATFORM

(71) Applicant: RedZone Robotics, Inc., Warrendale, PA (US)

(72) Inventors: Tim Renton, Auckland (NZ); Dan Metzinger, Allison Park, PA (US); Rebecca Wakeen, Pittsburgh, PA (US); Dimitrije Balanovic, Tauranga (NZ); Charles Hart, Pittsburgh, PA (US); Miguel Angel Taylor López, Cartago (CR); Marco Vinicio Herrera Valverde, San Rafael (CR)

(73) Assignee: RedZone Robotics, Inc., Warrendale, PA (US)

(21) Appl. No.: 19/575,339

(22) Filed: Mar. 23, 2026

Related U.S. Application Data
(60) Provisional application No. 63/776,727, filed on Mar. 24, 2025.

(51) Int. Cl. H04N 23/74; H04N 23/56; H04N 23/71; H04N 23/90

(52) U.S. Cl. CPC H04N 23/74; H04N 23/56; H04N 23/71; H04N 23/90

(57) ABSTRACT

An example includes a method of obtaining, from a plurality of sensor units disposed on a base unit to be oriented to have differing points of view, image data; analyzing, using a set of one or more processors, a pixel light value of a plurality of images obtained from the plurality of sensor units; determining, based on the analyzing, that a first pixel light value of a first image obtained from a first sensor unit deviates from an expected value for the first image; and dynamically adjusting, using the set of one or more processors, a first lighting unit of the first sensor unit to modify lighting provided by the first lighting unit.

### CROSS-REFERENCE TO RELATED APPLICATIONS

This application claims priority to U.S. provisional patent application Ser. No. 63/776,727, filed Mar. 24, 2025, and having the title “DYNAMIC LIGHTING CONTROL FOR MODULAR INFRASTRUCTURE INSPECTION PLATFORM,” the entire contents of which are incorporated by reference herein.

### BACKGROUND

Infrastructure such as pipes, conduits, tunnels, canals, manholes, shafts, chambers and the like need to be inspected and maintained. Visual inspections are often done as a matter of routine upkeep or in response to a noticed issue.

Various systems and methods are used to gather inspection data. For example, inspection data may be obtained by using closed circuit television (CCTV) cameras, sensors that collect visual images, and laser scanning. Such methods include traversing through a conduit or other infrastructure asset with an inspection unit and obtaining inspection data regarding the interior, e.g., images and/or other sensor data for visualizing infrastructure features such as pipe defects, cracks, intrusions, sediment build-up, etc. An inspection crew is often deployed to a location and individual pipe segments are inspected, for example in a serial fashion, to collect inspection data and analyze it.

### SUMMARY

Techniques that may be utilized during infrastructure inspection include collection of multi-sensor inspection (MSI) data and production of photorealistic imagery supplied by photogrammetry and three-dimensional (3D) modeling technology. This provides a user with a photorealistic, 3D images or video that can be reviewed. Such techniques rely on high-quality inspection data being collected.

To facilitate collection of high-quality inspection data, an embodiment provides techniques for dynamically controlling lighting modules. In an embodiment, individual sensor modules or units include one or more lighting modules or units (“lights”) that are dynamically controlled in a coordinated fashion based on image processing applied to images collected via the sensor modules or units.

In summary, an embodiment provides a method, comprising: obtaining, from a plurality of sensor units disposed on a base unit to be oriented to have differing points of view, image data; analyzing, using a set of one or more processors, a pixel light value of a plurality of images obtained from the plurality of sensor units; determining, based on the analyzing, that a first pixel light value of a first image obtained from a first sensor unit deviates from an expected value for the first image; and dynamically adjusting, using the set of one or more processors, a first lighting unit of the first sensor unit to modify lighting provided by the first lighting unit.

In an embodiment, the expected value is determined using a comparison between pixel light values from the plurality of sensor units. In an embodiment, the dynamically adjusting comprises modifying the lighting provided by the first lighting unit to balance the first pixel light value with a second pixel light value of a second image obtained from a second sensor unit. In an embodiment, the second image is obtained with a same time window as compared to the first image.

In an embodiment, the expected value for the first image is dynamically adjusted based on one or more pixel light values obtained from the plurality of sensor units.

In an embodiment, the expected light value for the first image is configured based on contextual data. In an embodiment, the contextual data comprises data indicative of one or more detected system components. In an embodiment, the contextual data comprises data indicative of one or more inspection environments. In an embodiment, the contextual data comprises data indicative of one or more deployment modes. In an embodiment, the one or more deployment modes comprises a horizontal deployment mode and a vertical deployment mode.

An embodiment provides a system, comprising: a set of one or more processors; and a non-transitory storage device comprising code that is executable by the set of one or more processors and configurable to perform any of the methods, or parts thereof, as described herein.

An embodiment provides a computer program product, comprising: a non-transitory storage device comprising code that is executable by a set of one or more processors and configurable to perform any of the methods, or parts thereof, as described herein.

The foregoing is a summary and is not intended to be in any way limiting. For a better understanding of the example embodiments, reference can be made to the detailed description and the drawings.

### BRIEF DESCRIPTION OF THE SEVERAL VIEWS OF THE DRAWINGS

FIG. 1 and FIG. 1A illustrate example modular infrastructure inspection devices according to an embodiment.

FIG. 2A, FIG. 2B, FIG. 2C, and FIG. 2D illustrate modular infrastructure inspection device examples with differing components according to an embodiment.

FIG. 3 illustrates an example method according to an embodiment.

FIG. 4 illustrates an example of a display including photorealistic imagery according to an embodiment.

FIG. 5 illustrates an example system according to an embodiment.

### DETAILED DESCRIPTION

It will be readily understood that the components of the embodiments, as generally described and illustrated in the figures herein, may be arranged and designed in a wide variety of ways in addition to the examples described herein. The detailed description uses examples, represented in the figures, but these examples are not intended to limit the scope of the claims.

Reference throughout this specification to “embodiment(s)” (or the like) means that a particular described feature or characteristic is included in that example. The feature or characteristic may or may not be claimed. The feature may or may not be relevant to other embodiments. For this detailed description, each example might be separable from or combined with another example, i.e., one example is not necessarily relevant to other examples.

Therefore, the described features or characteristics of the examples generally may be combined in any suitable manner, although this is not required. In the detailed description, numerous specific details are provided to give a thorough understanding of example embodiments. One skilled in the relevant art will recognize, however, that the claims can be practiced without one or more of the specific details found in the detailed description, or the claims can be practiced with other methods, components, etc. In other instances, well-known details are not shown or described to avoid obfuscation.

In an embodiment, a model is used to control one or more lighting units.

In an embodiment, the one or more lighting units are controlled independently but with a collective or global goal, for example using a global model that seeks to balance light contained in images obtained by imaging sensors having respective ones of the lighting modules or units. For example, in an embodiment, image processing is applied to determine pixel lighting values for pixels of different images captured by different imaging sensors of respective sensor modules or units. The pixel lighting values may be compared, for example using a global model and/or a common target value, which may change over time, to dynamically adjust one or more of the lighting modules or units.

In an embodiment, a dynamic lighting program is based on contextual data, for example configured to control lighting for a particular inspection environment, for a particular configuration of sensor modules or units, and for a particular configuration of lighting modules or units.

In an embodiment, a dynamic lighting program is selected or configured using contextual data obtained from a device or system context, such as detected component(s), physical orientation, a deployment type indicator, etc.

In an embodiment, the contextual data, such as detected component(s), are indicative of a particular inspection environment, such as a pipe size, a horizontal or vertical deployment, etc.

In an embodiment, the contextual data, such as the detected components, are indicative of a particular configuration of sensor modules or units, lighting modules or units, or a combination of the foregoing.

An embodiment provides a system including a device that implements hardware used to collect infrastructure inspection data.

An embodiment provides a device or sub-component thereof that is used to collect infrastructure inspection data.

An embodiment provides a method of dynamic lighting used in collecting infrastructure inspection data.

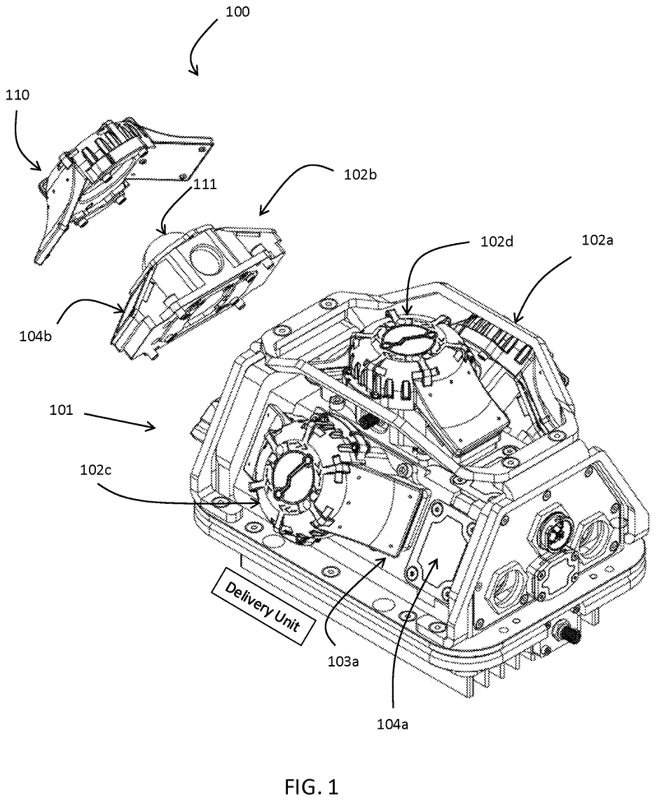

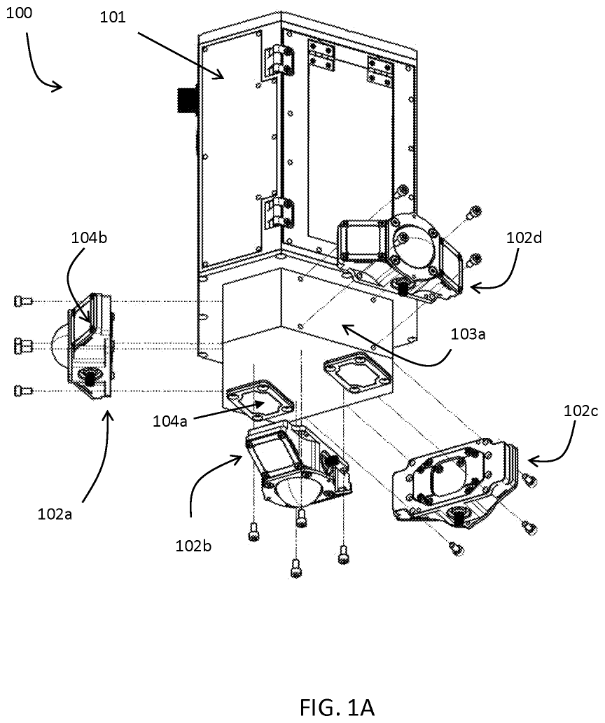

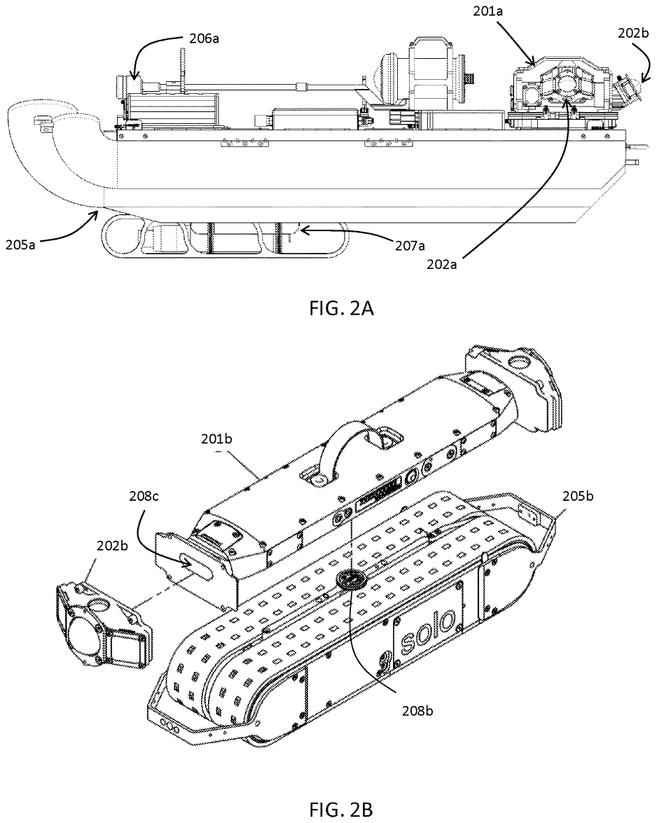

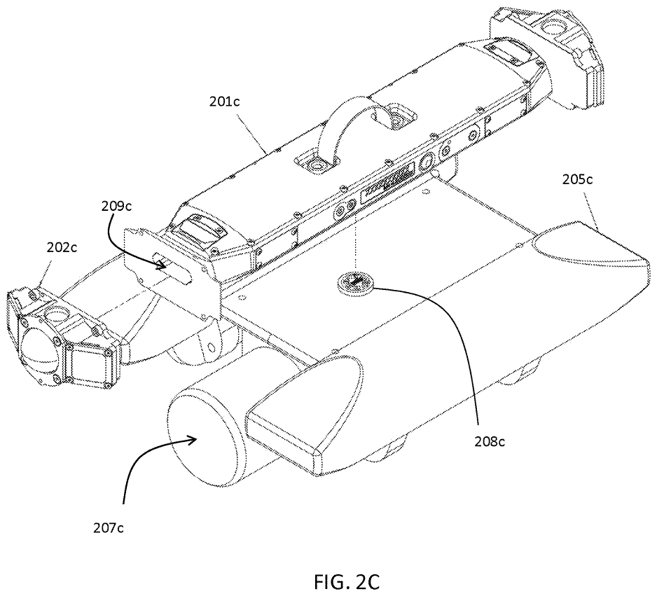

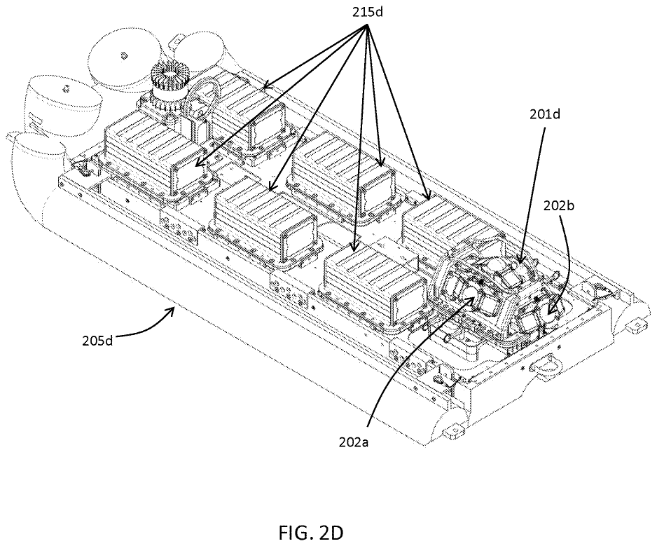

Referring to FIG. 1, an example view is provided in which a system including a modular infrastructure inspection device 100 is provided by an embodiment in the form of a base modular infrastructure inspection device 101 that supports a plurality of sensor units or modules 102a, 102b, 102c, 102d. Sensor unit or module 102b is illustrated in an expanded view to highlight the modularity of these sensor units or modules. Each sensor unit or module 102a-d cooperates to capture sensor data or sensor data streams relating to infrastructure. In an embodiment, by way of example, the respective sensor units or modules, e.g., 102a, are included in a modular fashion and attached to and are removable from base infrastructure inspection device 101. The respective sensor units or modules 102a-d in FIG. 1 may be attached to base infrastructure inspection device 101 at an interface, for example indicated at 103a. In an embodiment, differing form factors may be used for base infrastructure device 101, as indicated in FIG. 2A, FIG. 2B, and FIG. 2C, and different interface locations may be utilized, as further described herein. The example form factors illustrated are non-limiting, and an embodiment may provide dynamic lighting control to a variety of additional inspection unit types, including aerial inspection units or drones (“UAVs”) that collect inspection data related to above ground or underground infrastructure.

In the example of FIG. 1, sensor units or modules 102a, 102c, and 102d are attached radially to angular interfaces, one of which is indicated at 103a. The angled orientation as illustrated provides the combination of sensor modules 102a, 102c, and 102d with wide field of view, for example 180-degree view, with overlapping areas. In combination with sensor unit or module 102b, which may face forward and be angled upwardly, for example at about 45 degrees from a horizontal plane of based device sitting atop a delivery unit, the plurality of sensor units 102a-d allow for imaging a hemispherical, overlapping view of infrastructure such as a pipe, lateral or similar horizontal asset as base infrastructure inspection device 101 traverses horizontally through the infrastructure asset on a delivery unit. Other orientations for sensor units or modules maybe be chosen, for example via use of different form factors for base infrastructure device 101.

For example, illustrated in FIG. 1A is a base infrastructure inspection device 101 configured with sensor modules or units 102a-d arranged in an orientation that facilitates inspection of vertical infrastructure. For example, base infrastructure inspection device 101 of FIG. 1A may be suspended from a tether and tripod and lowered into a manhole or other vertical chamber, with sensor modules or units 102a-d arranged to capture hemispherical imagery as it descends and/or ascends into and out of the infrastructure asset.

As described herein, the sensor units or modules 102a-d may comprise cameras, lighting units, or other imaging units or sensors to produce data that is coordinated to provide a wide view of the infrastructure for multi-sensor inspection imaging (MSI) of the infrastructure asset. Additional or alternative sensing modules or units may be included, as described in connection with FIG. 2A-C.

Referring again to FIG. 1, in an embodiment, a sensor unit or module, e.g., 102a, includes a vision module having a camera and light emitting element(s), e.g., light emitting element 104b, such as a light emitting diode (LED) that is dynamically adjusted as described herein. In one example, a vision module such as sensor module or unit 102b includes a structured laser light projector as light emitting element, for example associated with or disposed within a chamber of the respective vision module. In an embodiment, other lighting elements 104a may be included, e.g., an RGB status light for indicating operational readiness.

In an embodiment, a sensor module or unit such as 102a includes a cap 110 that fits onto a chamber housing a camera and respective camera optics (lens) 111. In an embodiment, cap 110 provides a sealing fit (e.g., watertight or gas tight) onto the chamber and can be removed for imaging and/or obtaining other sensor data. In an embodiment, a sensor module or unit, e.g., 102a, includes a pressure sensor. In an embodiment, the pressure sensor provides data allowing an operatively coupled computer system, for example integrated with base infrastructure inspection device 101, to determine if the sensor module chamber and optics remain pressurized or have a leak.

In an embodiment, base infrastructure inspection device 101 is modular in that different sensor modules or units may be paired therewith. For example, sensor modules or units may comprise camera(s), visible light emitter(s), and sensors including one or more of an inertial measurement unit (IMU), one or more pressure sensors (e.g., for sensing a lost seal in sensor module or unit 102a), light detecting and ranging (LIDAR) unit(s), acoustic ranging unit(s) (sonar unit(s)), gas sensor(s), laser profiler(s), or a combination thereof.

As illustrated in FIG. 2A-D, a base infrastructure inspection device, e.g., 101, may be paired with varying delivery units 205a, 205b, 205c. In the example illustrated in FIG. 2A, delivery unit 205a is in the form of a float system, where base infrastructure inspection device 201a is attached to delivery unit 205a to sit on top thereof, with sonar unit 207a and laser profiler 206a included as additional sensor modules or units in addition to vision-based sensors modules or units 202a, 202b, arranged in the orientation shown in FIG. 2A.

As shown in FIG. 2B, delivery unit 205b may take another form, here a tractor unit having tracks covering substantially the entire width of the tractor unit, noting that other tractor units may be used as a delivery unit. In the example of FIG. 2B, base infrastructure inspection device 201b is a smaller form factor than that shown at 101 of FIG. 1, sized appropriately for attachment to delivery unit 205b and having different interfaces for accepting sensor modules or units. As indicated, sensor modules or units, e.g., 202b, may be attached at different locations on base infrastructure inspection device 201b when compared to base infrastructure inspection device 101, for example at the front and rear thereof, via a power and data connection or like interface 208c. Base infrastructure inspection device 201b may in turn be attached to delivery unit 205b via a connector 208b, which may include power and/or data connections or solely be a physical connection. In an embodiment, a universal connector 208b is provided to delivery unit 205b and base infrastructure inspection device 201b such that the various form factors of base infrastructure inspection devices and respective delivery units are interchangeable.

FIG. 2C illustrates another example in which base infrastructure inspection device 201c, like FIG. 2B, includes sensor modules or units, e.g., 202c, at the front and back thereof, with sensor modules or units, e.g., 202c, having a complementary connector (not illustrated) that connects or attaches to delivery unit 205c, here FIG. 2C shows an example in the form of a float or raft system and paired sonar unit 207c. As in the view of FIG. 2B, sensor modules or units, e.g., 202c, may be connected or attached to an interface 209c, similar to interface 208b, of base infrastructure inspection device 201c, offering one or more of power and data.

In the example illustrated in FIG. 2D, delivery unit 205d is in the form of a float system, where base infrastructure inspection device 201d is attached to delivery unit 205d to sit on top thereof, with light detecting and ranging (LIDAR) units included as additional sensor modules or units, in addition to vision-based sensors modules or units 202a, 202b, arranged in the orientation shown in FIG. 2D. As with sensor module or unit 202a that attaches to base infrastructure inspection unit 201d, base infrastructure inspection unit 202d may attach to delivery unit 205d or component thereof, e.g., a circuit board or connection port thereof, via an interface to derive power and/or data. In the example of FIG. 2D, delivery unit 205d includes a set of batteries 215d, which may supply power or auxiliary power to base infrastructure inspection device 201d. Likewise, other or additional sensors may derive power and/or data from delivery unit 205d.

As described, base infrastructure inspection devices 101, 201a-c, are modular in that differing sensor modules and/or differing delivery units may be attached thereto. In one example, one or more modules or units, e.g., a delivery unit, may be omitted. For example, in a form factor for vertical manhole inspection where, for example, base infrastructure inspection device 101 is suspended from a tripod by a hook or tether system and lowered and raised into or from a manhole, vertical shaft or chamber, the delivery unit is omitted in favor of suspending base infrastructure inspection device 101 from a cable or tether.

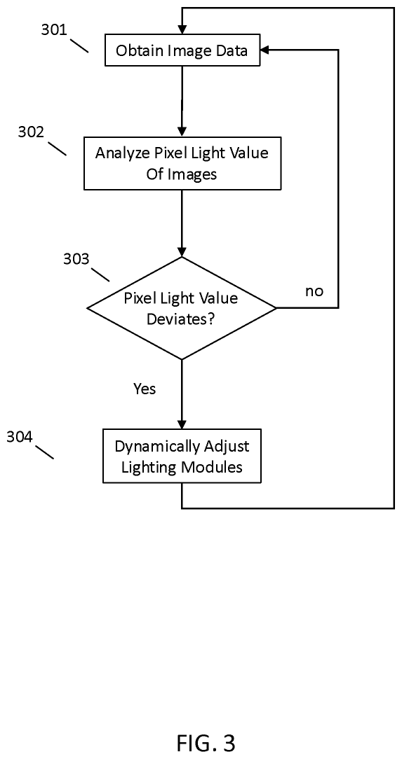

Referring to FIG. 3, the modular infrastructure inspection devices may be used to capture, analyze and display multi-sensor inspection (MSI) data. As shown in FIG. 3, an example method of dynamic lighting may include obtaining, from a plurality of sensor units disposed on a base unit to be oriented to have differing points of view, image data, as indicated at 301. In an embodiment, the method includes analyzing, using a set of one or more processors, a pixel light value of a plurality of images obtained from the plurality of sensor units, as indicated at 302. The method may include determining, based on the analyzing, that a first pixel light value of a first image obtained from a first sensor unit deviates from an expected value for the first image, as indicated at 303, and dynamically adjusting, using the set of one or more processors, a first lighting unit of the first sensor unit to modify lighting provided by the first lighting unit, indicated at 304. As illustrated, method may loop to continuously check and update, as applicable. If the determination at 303 indicates that the lighting value does not deviate from an expected lighting value, the method may loop to another step such as obtaining additional image data. In an embodiment, the set of one or more processors may reside in a base of a modular infrastructure inspection device, e.g., 101 of FIG. 1.

In an embodiment, the expected value is determined using a comparison between pixel light values from the plurality of sensor units. For example, during deployment in an underground, horizontal conduit, a float unit, e.g., as depicted in the examples of FIGS. 2A, 2C, and 2D, may drift towards one wall of the conduit. This movement of the unit within the conduit may cause more lighting to be represented in images captured from sensor unit(s) on one side versus another, such as more light being captured by sensor unit 102a as compared with sensor unit 102c in FIG. 1.

In an embodiment, the dynamically adjusting may include modifying the lighting provided, e.g., by the first lighting unit, to balance the lighting detectable in the images, e.g., the first pixel light value being balanced with a second pixel light value of a second image obtained from a second sensor unit. This may be controlled, for example, by a lighting model that encourages balancing between the sensor units as a global goal, using periodic or intermittent comparisons to dynamically adjust the lighting modules. As may be appreciated, in an embodiment, the pixel light values used for comparison may be obtained in the same time window, e.g., at the same time or nearly the same time.

In an embodiment, a global value may be used as a target lighting value. In an embodiment, the global value may be determined from a global model. In an embodiment, the global model may be based on or matched to an expected infrastructure 3D shape, such as a cylinder. By way of example, an average value across all images may be predetermined or calculated and used as a goal for each image or image part (if more than one lighting module illuminates an area for a given image sensor).

In an embodiment, a target lighting value may be obtained dynamically from another image or part thereof. For example, a part of an image obtained by unit 102b may indicate imbalanced lighting with respect to sides of the inspection platform, e.g., left versus right side. As such, this image's pixel light values may indicate lighting imbalance and be used to adjust another unit, such as unit 102c or 102a.

In an embodiment, the expected value, e.g., for the first image, is dynamically adjusted. By way of example, the expected value may be adjusted based on one or more pixel light values obtained from the plurality of sensor units. In an embodiment, a model used to dynamically adjust the lighting provided by respective lighting modules may seek as a goal a respective target value, such as a mean or an average value, that changes over time as the inspection unit moves through the inspection environment. For example, a value determined from the average pixel lighting values across all images in a set, e.g., those captured form the plurality of sensors at the same time or within the same time window, may be used as a target or expected value against which respective individual images or pixel lighting values are compared and lighting module(s) adjusted, for determination of an updated pixel lighting value at a next time step.

In an embodiment, the expected light value, e.g., for the first image, is configured based on contextual data. In an embodiment, the contextual data includes data indicative of one or more detected system components. For example, the detected system components may be indicative of a form factor, such as those illustrated in FIG. 2A-D. In an embodiment, the contextual data includes data indicative of one or more inspection environments. For example, form factors may be matched to environments, a data pattern (such as pixel light values detected while inspecting a cylinder using a form factor) or similar may be used to provide data indicating what type of lighting conditions are expected or modeled for respective lighting modules or units. In an embodiment, the contextual data includes data indicative of one or more deployment modes, for example the one or more deployment modes may include a horizontal deployment mode and a vertical deployment mode. As may be appreciated, different lighting patterns and dynamic control programs may be needed, for example based on contextual data, include when deploying horizontally into a known conduit type such as a cylinder as compared to an irregularly shaped void or chamber, such as a manhole or vertical shaft.

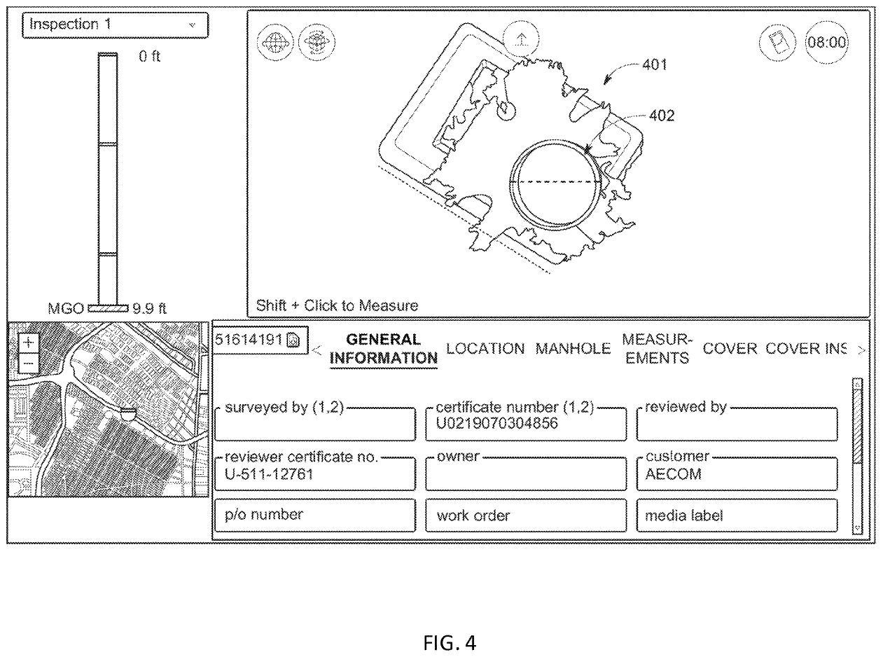

Illustrated in FIG. 4 is an example of a GUI having a photorealistic image 401 displayed therein. With the amount of points provided by the photo-realistic image 401 and the structure of the underlying model, e.g., with faces of similar or the same length, a user may highlight or otherwise indicate a feature in the model, such as the manhole's opening, a pipe diameter, a crack or other defect, as illustrated at 402, to have a dimension calculated. Here, a user may indicate a feature of interest, e.g., draw across the opening 402 (indicated by the dashed line in FIG. 4), to have the dimension calculated, such as receiving the diameter of the feature in millimeters, centimeters, inches, etc. As may be appreciated, due to the underlying structure of faces or points of the model, which may be evenly spaced for a given resolution, any dimension selected may be used to scale other dimensions, e.g., the length of the infrastructure imaged and selected, as indicated with the dotted line in FIG. 4. Alternatively, or additionally, the dimensions of a set of features, e.g., commonly used features such as pipe diameter size, internal chamber size, depth, water level, etc., may be automatically calculated and provided to the user, with or without the need to interface with the model.

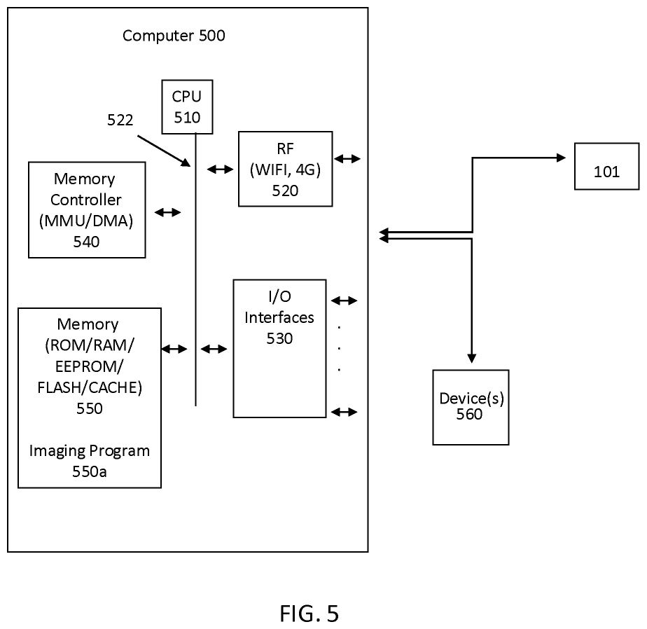

It will be readily understood that certain embodiments can be implemented using any of a wide variety of devices or combinations of devices. Referring to FIG. 5, an example device that may be used in implementing one or more embodiments includes a computing device (computer) 500, for example included in an inspection system 100, such as base infrastructure inspection device 101 as illustrated in FIG. 1, component thereof, and/or a separate system (e.g., a tablet, laptop or desktop computer, a server or workstation, etc.).

The computer 500 may execute program instructions or code configured to obtain, store and process sensor data (e.g., images from an imaging device, laser data, sonar data, or point cloud data from a sensor device, as described herein) and perform other functionality of the embodiments. Components of computer 500 may include, but are not limited to, a processing unit 510, which may take a variety of forms such as a central processing unit (CPU), a graphics processing unit (GPU), a combination of the foregoing, etc., a system memory controller 540 and memory 550, and a system bus 522 that couples various system components including the system memory 550 to the processing unit 510. The computer 500 may include or have access to a variety of non-transitory computer readable media. The system memory 550 may include non-transitory computer readable storage media in the form of volatile and/or nonvolatile memory devices such as read only memory (ROM) and/or random-access memory (RAM). By way of example, and not limitation, system memory 550 may also include an operating system, application programs, other program modules, and program data. For example, system memory 550 may include application programs such as image processing software or imaging program 550a, such as a software program for performing some or all of the steps illustrated in FIG. 3. Data may be transmitted by wired or wireless communication, e.g., to or from a base infrastructure inspection device 101 to another computing device, e.g., a remote device or system 560, such as a cloud server that offers image processing, model formation or reference model retrieval, computer vision and auto-coding processing, etc. As described herein, certain functionality may take place on-board an inspection unit without being provided for remote processing, permitting real-time or near real-time adjustment, such as that applied for dynamic lighting.

A user can interface with (for example, enter commands and information) the computer 500 through input devices such as a touch screen, keypad, etc. A monitor or other type of display screen or device can also be connected to the system bus 522 via an interface, such as interface 530. The computer 500 may operate in a networked or distributed environment using logical connections to one or more other remote computers or databases. The logical connections may include a network, such local area network (LAN) or a wide area network (WAN) but may also include other networks/buses.

It should be noted that various functions described herein may be implemented using processor executable instructions stored on a non-transitory storage medium or device. A non-transitory storage device may be, for example, an electronic, electromagnetic, or semiconductor system, apparatus, or device, or any suitable combination of the foregoing. More specific examples of a non-transitory storage medium include the following: a portable computer diskette, a hard disk, a random-access memory (RAM), a read-only memory (ROM), an erasable programmable read-only memory (EPROM or Flash memory), a portable compact disc read-only memory (CD-ROM), a solid-state drive, or any suitable combination of the foregoing. In the context of this document “non-transitory” media includes all media except non-statutory signal media.

Program code embodied on a non-transitory storage medium may be transmitted using any appropriate medium, including but not limited to wireless, wireline, optical fiber cable, RF, etc., or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), a personal area network (PAN) or the connection may be made through other devices (for example, through the Internet using an Internet Service Provider), through wireless connections, or through a hard wire connection, such as over a USB or another power and data connection.

Example embodiments are described herein with reference to the figures, which illustrate various example embodiments. It will be understood that the actions and functionality may be implemented at least in part by program instructions. These program instructions may be provided to a processor of a device to produce a special purpose machine, such that the instructions, which execute via a processor of the device implement the functions/acts specified.

It is worth noting that while specific elements are used in the figures, and a particular illustration of elements has been set forth, these are non-limiting examples. In certain contexts, two or more elements may be combined, an element may be split into two or more elements, or certain elements may be re-ordered, re-organized, combined or omitted as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting, and that various other changes and modifications may be affected therein by one skilled in the art without departing from the scope or spirit of the disclosure.

What is claimed is:

1. A method, comprising:
obtaining, from a plurality of sensor units disposed on a base unit to be oriented to have differing points of view, image data;
analyzing, using a set of one or more processors, a pixel light value of a plurality of images obtained from the plurality of sensor units;
determining, based on the analyzing, that a first pixel light value of a first image obtained from a first sensor unit deviates from an expected value for the first image; and
dynamically adjusting, using the set of one or more processors, a first lighting unit of the first sensor unit to modify lighting provided by the first lighting unit.

2. The method of claim 1, wherein the expected value is determined using a comparison between pixel light values from the plurality of sensor units.

3. The method of claim 2, wherein the dynamically adjusting comprises modifying the lighting provided by the first lighting unit to balance the first pixel light value with a second pixel light value of a second image obtained from a second sensor unit.

4. The method of claim 3, wherein the second image is obtained with a same time window as compared to the first image.

5. The method of claim 1, wherein the expected value for the first image is dynamically adjusted based on one or more pixel light values obtained from the plurality of sensor units.

6. The method of claim 1, wherein the expected light value for the first image is configured based on contextual data.

7. The method of claim 6, wherein the contextual data comprises data indicative of one or more detected system components.

8. The method of claim 6, wherein the contextual data comprises data indicative of one or more inspection environments.

9. The method of claim 6, wherein the contextual data comprises data indicative of one or more deployment modes.

10. The method of claim 9, wherein the one or more deployment modes comprises a horizontal deployment mode and a vertical deployment mode.

11. A system, comprising:
a set of one or more processors; and
a non-transitory storage device comprising code that is executable by the set of one or more processors and configurable to cause:
obtaining, from a plurality of sensor units disposed on a base unit to be oriented to have differing points of view, image data;
analyzing, using a set of one or more processors, a pixel light value of a plurality of images obtained from the plurality of sensor units;
determining, based on the analyzing, that a first pixel light value of a first image obtained from a first sensor unit deviates from an expected value for the first image; and
dynamically adjusting, using the set of one or more processors, a first lighting unit of the first sensor unit to modify lighting provided by the first lighting unit.

12. The system of claim 11, wherein the expected value is determined using a comparison between pixel light values from the plurality of sensor units.

13. The system of claim 12, wherein the dynamically adjusting comprises modifying the lighting provided by the first lighting unit to balance the first pixel light value with a second pixel light value of a second image obtained from a second sensor unit.

14. The system of claim 13, wherein the second image is obtained with a same time window as compared to the first image.

15. The system of claim 11, wherein the expected value for the first image is dynamically adjusted based on one or more pixel light values obtained from the plurality of sensor units.

16. The system of claim 11, wherein the expected light value for the first image is configured based on contextual data.

17. The system of claim 16, wherein the contextual data comprises data indicative of one or more detected system components.

18. The system of claim 16, wherein the contextual data comprises data indicative of one or more inspection environments.

19. The system of claim 16, wherein the contextual data comprises data indicative of one or more deployment modes.

20. A computer program product, comprising:
a non-transitory storage device comprising code that is executable by a set of one or more processors and configurable to cause:
obtaining, from a plurality of sensor units disposed on a base unit to be oriented to have differing points of view, image data;
analyzing, using a set of one or more processors, a pixel light value of a plurality of images obtained from the plurality of sensor units;
determining, based on the analyzing, that a first pixel light value of a first image obtained from a first sensor unit deviates from an expected value for the first image; and
dynamically adjusting, using the set of one or more processors, a first lighting unit of the first sensor unit to modify lighting provided by the first lighting unit.
